(19) United States
(12) Patent Application Publication
(10) Pub. No.: US 2026/0225670 A1
(43) Pub. Date: Aug. 6, 2026

(54) IMPEDANCE-BASED CONTROLLER INCLUDING PINCH PREVENTION FOR ELECTRONIC ACTIVE AERODYNAMIC SURFACES

(71) Applicant: GM GLOBAL TECHNOLOGY OPERATIONS LLC, Detroit, MI (US)

(72) Inventors: Raed Nasim ABUAITA, Fenton, MI (US); Trevor KYLE, Farmington Hills, MI (US); Brian K. SAYLOR, South Lyon, MI (US)

(21) Appl. No.: 19/044,214

(22) Filed: Feb. 3, 2025

(51) Int. Cl. B62D 37/02; B60K 11/08

(52) U.S. Cl. CPC B62D 37/02; B60K 11/085

(57) ABSTRACT

A control system for a moveable device of a vehicle includes a position sensor configured to measure an actual displacement of the moveable device. A force transducer is configured to measure a force applied by a motor to adjust a position of the moveable device. An impedance detection module is configured to generate a reference displacement in response to a desired displacement and the force. A summer is configured to generate an error in response to the reference displacement and the actual displacement. A proportional integral derivative (PID) module is configured to output a revised desired displacement to control the motor in response to the error. Examples of the moveable device include an electronic active aerodynamic (EAA) system such as an adjustable shutter or an adjustable spoiler.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to motor control systems, and more particularly to a motor control system configured to adjust a position of a moveable device with pinch protection.

Vehicles may include moveable devices such as electronic active aerodynamic (EAA) systems such as spoilers or shutters. Operating positions of the EAA systems can be adjusted to selectively increase or decrease downforce and/or increase or decrease airflow.

### SUMMARY

A control system for a moveable device of a vehicle includes a position sensor configured to measure an actual displacement of the moveable device. A force transducer is configured to measure a force applied by a motor to adjust a position of the moveable device. An impedance detection module is configured to generate a reference displacement in response to a desired displacement and the force. A summer is configured to generate an error in response to the reference displacement and the actual displacement. A proportional integral derivative (PID) module is configured to output a revised desired displacement to control the motor in response to the error.

In other features, the moveable device includes an electronic active aerodynamic (EAA) system. The moveable device includes an adjustable shutter. The moveable device includes an adjustable spoiler.

In other features, the impedance detection module selectively determines the reference displacement in response to a relationship:

$${X}_{r} = \frac{{F}_{e} - {M}_{r} ( {\ddot{X}}_{r} - {\ddot{X}}_{d} ) - {D}_{r} ( {\dot{X}}_{r} - {\dot{X}}_{d} )}{{K}_{r}} + {X}_{d}$$

where Mᵣ, Dᵣ, and Kᵣ are constant gain parameters that define soft contact, Xᵣ is the reference displacement, X_{d} is the desired displacement, \ddot{X}ᵣ is a reference acceleration, \ddot{X}_{d} is a desired acceleration, \dot{X}ᵣ is a reference velocity, and \dot{X}_{d} is a desired velocity.

In other features, at least one of: the impedance detection module sets the desired displacement equal to the reference displacement at vehicle speeds greater than a predetermined vehicle speed; and the impedance detection module sets the desired displacement equal to the reference displacement when the moveable device is moved in a first direction and based on the relationship when the moveable device is moved in a second direction opposite to the first direction.

In other features, when the impedance detection module detects an obstruction, the impedance detection module is configured to take remedial action including at least one of stopping forward motion, reversing for a predetermined period, reversing by a predetermined distance, or pausing for a predetermined period. After the remedial action, the impedance detection module is configured to re-attempt forward motion. If the obstruction is detected by the impedance detection module after re-attempting forward motion, the impedance detection module is configured to reverse to a starting position.

A control system for a moveable device of a includes a position sensor configured to measure an actual displacement of the moveable device. A summer is configured to generate an error in response to a desired displacement and the actual displacement. A proportional integral derivative (PID) module configured to generate a displacement output in response to the error. A force transducer is configured to measure a force applied by a motor to adjust a position of the moveable device. An impedance detection module configured to sense an obstruction based on the force and to generate a revised reference displacement to control a motor moving the moveable device in response to the displacement output and the force.

In other features, the moveable device includes an electronic active aerodynamic (EAA) system. The moveable device includes an adjustable shutter. The moveable device includes an adjustable spoiler.

In other features, at least one of the impedance detection module sets the desired displacement based on the displacement output at vehicle speeds greater than a predetermined vehicle speed; and the impedance detection module sets the desired displacement based on the displacement output when the moveable device is moved in a first direction and based on the force and the displacement output when the moveable device is moved in a second direction opposite to the first direction.

In other features, when the impedance detection module detects an obstruction, the impedance detection module is configured to take remedial action including at least one of stopping forward motion, reversing for a predetermined period, reversing by a predetermined distance, or pausing for a predetermined period. After the remedial action, the impedance detection module is configured to re-attempt forward motion. If the obstruction is detected by the impedance detection module after re-attempting forward motion, the impedance detection module is configured to reverse to a starting position.

A control system for controlling a position of a moveable device of a vehicle includes a position sensor configured to measure an actual displacement of the moveable device. A summer is configured to generate an error in response to a desired displacement and the actual displacement. An impedance detection module is configured to receive the desired displacement and the actual displacement, estimate a pinch force in response to a sum of products of a position difference and a first gain, a velocity difference and a second gain, and an acceleration difference and a third gain, and generate an output displacement for a motor moving the moveable device based on the error when the pinch force is zero and take remedial action when the pinch force is not zero.

In other features, the moveable device includes an electronic active aerodynamic (EAA) system. The moveable device includes an adjustable shutter. The moveable device includes an adjustable spoiler.

In other features, at least one of: the impedance detection module sets the output displacement based on the error at vehicle speeds greater than a predetermined vehicle speed; the impedance detection module sets the output displacement based on the error when the moveable device is moved in a first direction; and the impedance detection module sets the output displacement based on the error and the pinch force when the moveable device is moved in a second direction opposite to the first direction.

In other features, when the impedance detection module detects an obstruction based on the pinch force, the impedance detection module is configured to take remedial action including at least one of stopping forward motion, reversing for a predetermined period, reversing by a predetermined distance, or pausing for a predetermined period. After the remedial action, the impedance detection module is configured to re-attempt forward motion. If the obstruction is detected by the impedance detection module after the remedial action, the impedance detection module is configured to reverse to a starting position.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example of a vehicle including a moveable device such as an electronic active aerodynamic (EAA) system with an adjustable position according to the present disclosure;

FIG. 2 is a functional block diagram of an example of a controller including an impedance detection module configured to control the moveable device and detect a pinch event according to the present disclosure;

FIG. 3 is a functional block diagram of an example of a control system implemented by the controller of FIG. 2 according to the present disclosure;

FIG. 4 is a flowchart of an example of a method for controlling the moveable device with pinch protection according to the present disclosure;

FIG. 5 is a functional block diagram of another example of a control system with pinch protection according to the present disclosure;

FIG. 6A is a graph illustrating an example of operation of the moveable device without pinch control;

FIG. 6B is a graph illustrating an example of operation of the moveable device with pinch control according to the present disclosure;

FIG. 7 is a functional block diagram of another example of a control system with pinch protection according to the present disclosure;

FIG. 8 is a functional block diagram of another example of a control system with pinch protection based on proportional and integral terms of a proportion integral derivative (PID) module according to the present disclosure;

FIG. 9 is a graph illustrating proportional and integral terms during a pinch;

FIG. 10 is a flowchart of a method for detecting a pinch event based on the proportional and integral terms according to the present disclosure; and

FIG. 11 is a functional block diagram of another example of a control system with pinch protection based on a current gradient according to the present disclosure;

In the drawings, reference numbers may be reused to identify similar and/or identical elements.

### DETAILED DESCRIPTION

While a control system is described below in the context of electric motors for adjusting the position of a moveable device such as an electronic active aerodynamic (EAA) system of a vehicle, the control system can be used for controlling other types of moveable devices.

Vehicles with EAA systems have a high risk of inducing a pinch event during the closure process when lowering or closing while the vehicle is parked or operating at low speeds. In some examples, the motor control system uses an impedance-based control system to provide pinch protection by detecting obstruction of the moving device. The impedance-based control system is not as susceptible to factors such as friction or corrosion that limit current pinch detection methods while providing a more proactive approach to preventing pinches. The control system prevents a pinch event by enabling soft contact between the closure and an object such as a hand or arm.

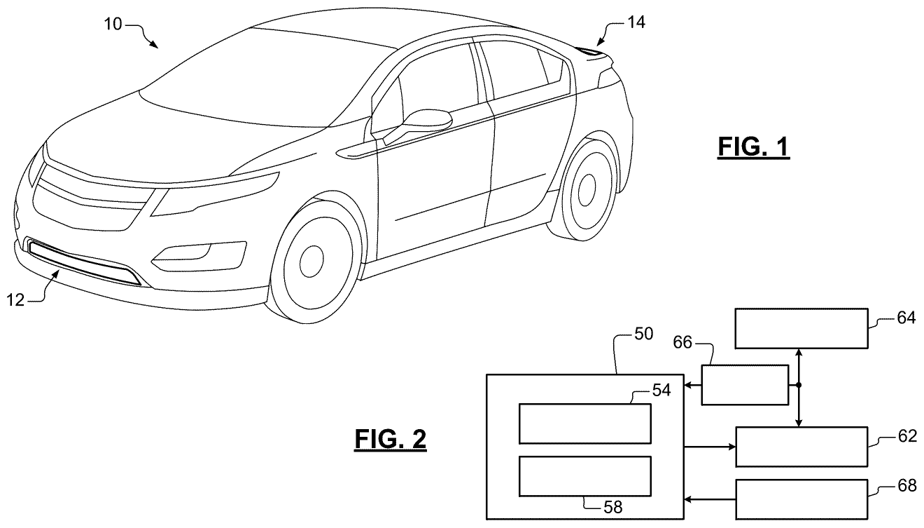

Referring now to FIGS. 1 and 2, a vehicle 10 includes one or more moveable devices that have adjustable positions. For example in FIG. 1, the vehicle 10 includes one or more moveable devices such a shutter 12 that opens and closes to adjust airflow under a hood of the vehicle 10 and/or a spoiler 14 that moves up and down to adjust rear downforce. The positions of the one or more moveable devices are adjusted between first and second positions (such as up and down positions of the spoiler 14 and/or open and closed positions of the shutter 12) using an electric motor. When the moveable device is lowering or closing and vehicle is stopped or moving slowly, it is possible for an object (such as fingers, a hand, an arm, and/or other objects) to be inserted between the EAA systems and a mounting area surrounding the EAA systems while the moveable device is being closed.

In FIG. 2, a controller 50 is configured to control a motor 62 for adjusting the position of a moveable device 64. In some examples, a force transducer 66 is configured to sense force output by the motor 62 to adjust the position of the moveable device 64. In some examples, a position sensor 68 is configured to sense a position or actual displacement of the moveable device 64. In some examples, the controller 50 includes a proportional, integral, and derivative (PID) controller 54 and an impedance detection module 58. In some examples, the impedance detection module 58 is based on a mass-damper-spring model described further below.

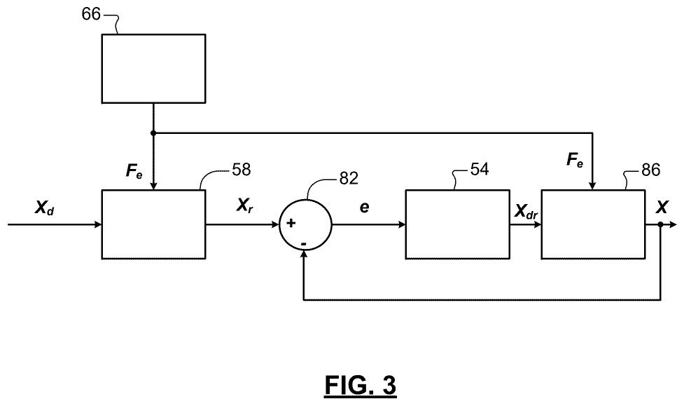

Referring now to FIG. 3, a control system implemented by the controller 50 is shown. The impedance detection module 58 receives a desired displacement (X_{d}) for the moveable device 64. The force transducer 66 senses and outputs force feedback Fₑ to the impedance detection module 58. The impedance detection module 58 outputs a reference displacement (Xᵣ) in response to the force feedback Fₑ and the desired displacement (X_{d}) as will be described below.

A summer 82 includes a non-inverting input receiving the reference displacement Xᵣ and an inverting input receiving an actual displacement X output by a plant 86 (corresponding to the motor 62, the moveable device 64, and an obstruction (if applicable)). An error output e of the summer 82 is input to a PID module 84 configured to output a revised desired displacement X_{dr} to the plant 86.

The force feedback Fₑ is indicative of an external force (e.g., a pinch force) detected by the force transducer 66. The impedance detection module 58 generates the reference displacement (Xᵣ) based on:

$${F}_{e} = {M}_{r} ( {\ddot{X}}_{r} - {\ddot{X}}_{d} ) + {D}_{r} ( {\dot{X}}_{r} - {\dot{X}}_{d} ) + {K}_{r} ( {X}_{r} - {X}_{d} ) ; or$$

$${X}_{r} = \frac{{F}_{e} - {M}_{γ} ( {\ddot{X}}_{r} - {\ddot{X}}_{d} ) - {D}_{r} ( {\dot{X}}_{r} - {\dot{X}}_{d} )}{{K}_{r}} + {X}_{d}$$

where Mᵣ, Dᵣ, and Kᵣ are constant gain parameters that define soft contact (and include the mass of the mechanical component, the effective stiffness, and the effective damping), Xᵣ is a reference displacement, X_{d} is a desired displacement, \ddot{X}ᵣ is a reference acceleration, \ddot{X}_{d} is a desired acceleration, \dot{X}ᵣ is a reference velocity, and \dot{X}_{d} is a desired velocity.

Mᵣ, Dᵣ, and Kᵣ are parameters of the impedance detection module 58 that dictate soft contact. The impedance detection module 58 sets up a reference force interaction model and governs the revised desired displacement X_{dr} based on the feedback force. The impedance detection module 58 computes a reference displacement Xᵣ. The actual displacement X of the moveable device 64 is compared to the reference displacement Xᵣ and a difference or error e is generated. The error e is input to the PID module 84. The PID module 84 generates the revised desired displacement X_{dr} for the motor 62. The control system creates soft contact between the moveable device 64 and its environment.

In some examples, the impedance detection module 58 is enabled at vehicle speeds S less than a predetermined vehicle speed (e.g., 10 mph or another speed). In some examples, the impedance detection module 58 is enabled when the moveable device is moved in a first direction (e.g., closing or moving to a lowered position) and disabled when the moveable device is moved in a second direction opposite to the first direction (e.g., opening or moving to a raised position). In some examples, the reference displacement is set equal to the desired displacement when the impedance detection module 58 is disabled (e.g., due to speed or movement direction).

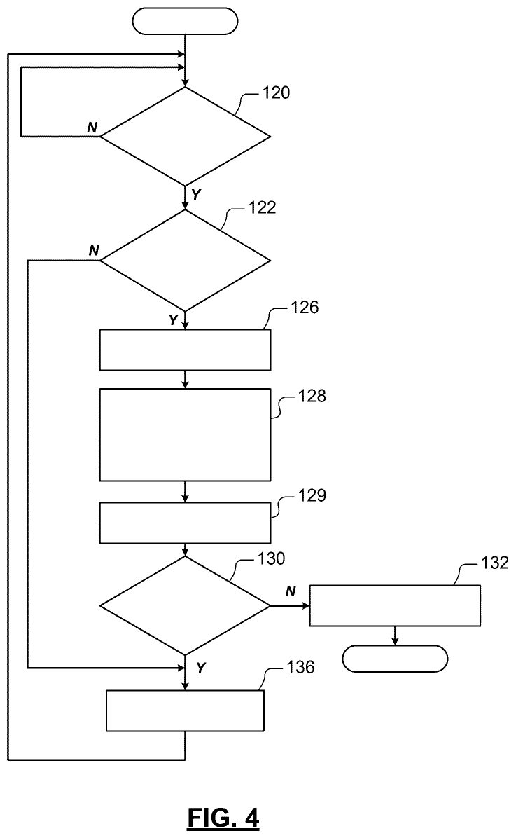

Referring now to FIG. 4, a method for controlling the moveable device is shown. At 120, the method determines whether the moveable device is closing or lowering. If 120 is true, the method continues with 122 and determines whether pinch force is detected. If true, the method performs impedance control at 126 as described above. If the pinch force is detected at 128, the method performs a remedial action such as stopping forward motion, reversing for a predetermined period, reversing by a predetermined distance, and/or pausing for a predetermined period. At 129, the method re-attempts forward motion (e.g., closing) at the same or slower speed.

At 130, the method determines whether the pinch force is released. If 122 is false or 130 is true, the method continues at 136 and continues closing. If 130 is false, the method continues at 132, reverses motion to an original starting position, and control ends.

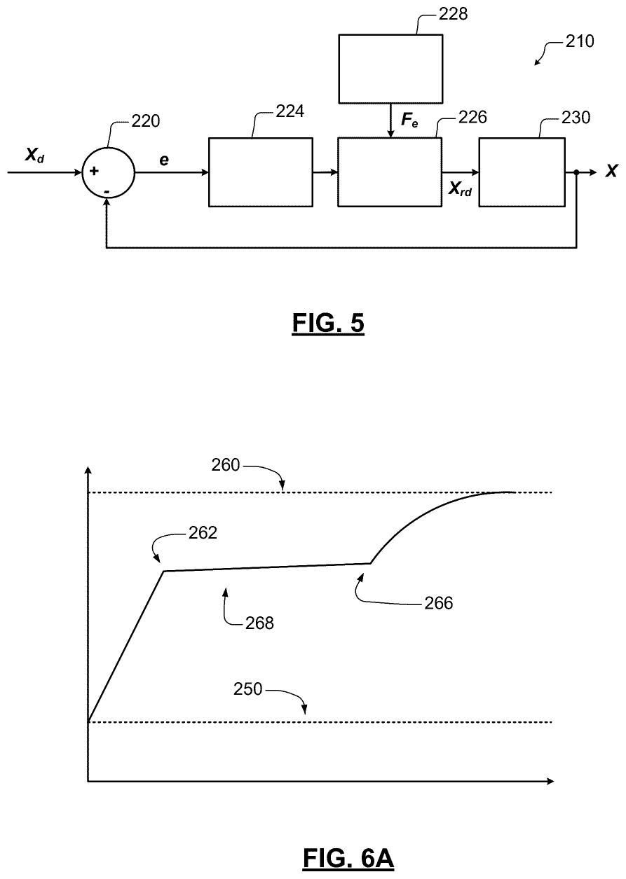

Referring now to FIG. 5, another control system 200 is shown. A desired displacement X_{d} is input to a non-inverting input of a summer 220. An inverting input of the summer 220 receives the actual displacement X of a plant 230. A difference or error e is output to a PID module 224. An output displacement generated by the PID module 224 is input to an impedance detection module 226 that also receives a measured force feedback Fₑ from a force transducer 228. When no obstruction is detected, the output of the PID module 224 is used. When an obstruction is detected, the impedance detection module 226 outputs a revised desired displacement X_{dr} to the plant 230.

In this example, the moveable object is normally operated using the PID module 224. When the obstruction is detected, the impedance detection module 226 is configured to perform a remedial action. For example, the impedance detection module 226 stops forward motion, reverses for a predetermined period, reverses by a predetermined distance, and/or pauses for a predetermined period and then re-attempts forward motion (e.g., closing) at the same or slower speed. If the obstruction is cleared, the motor continues closing or lowering the moveable object. If the obstruction is not cleared, the motor reverses direction (and opens or raises to a highest position).

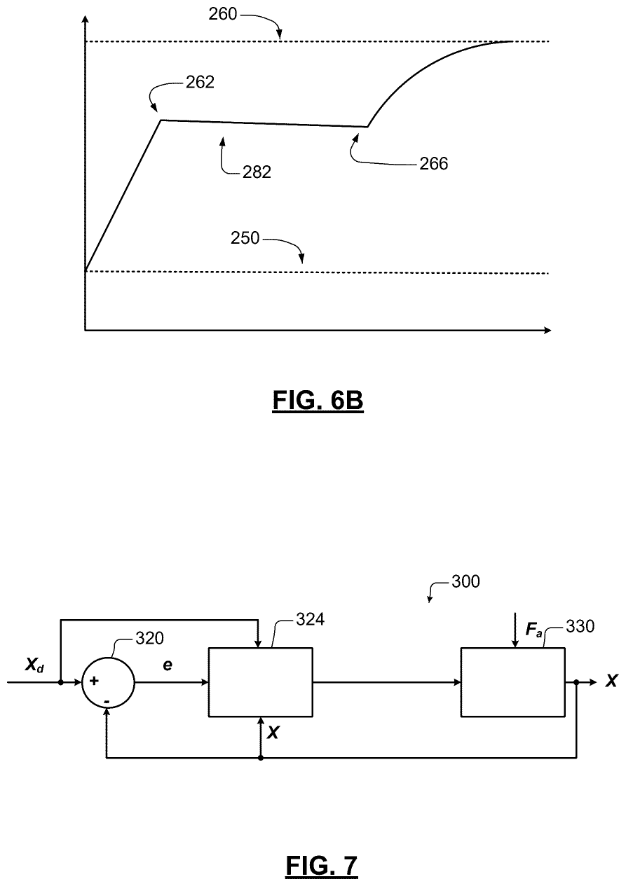

Referring now to FIG. 6A, operation of the control system without pinch control is shown. The control system begins moving the moveable object from a start position 250. The moveable object moves steadily until a blockage occurs at blockage insertion position 262. Between the blockage insertion position 262 and a blockage removal position 266, the control system without pinch control continues to pinch an object causing the blockage (e.g., at 268). As a result, force continues to be applied to the blockage and the blockage may be difficult to remove. After the blockage is removed at 266, the control system continues moving to the target position.

Referring now to FIG. 6B, operation of the control system with pinch control according to the present disclosure is shown. The control system begins moving the moveable object from a start position 250. The moveable object moves steadily until a blockage occurs at a blockage insertion position 262. Between the blockage insertion position 262 and a blockage removal position 266, the control system reverses the motor or takes other remedial action to allow the blockage to be removed (e.g., at 282). If the blockage is removed at 266, the control system continues to move the moveable object to the target position 260. If the blockage is not removed after a predetermined period, the EAA system reverses to the starting position 250.

Referring now to FIG. 7, another control system 300 is shown that does not include a force transducer. A desired displacement X_{d} is input to a non-inverting input of a summer 320. An inverting input of the summer 320 receives an actual displacement. A difference or error e is output by the summer 320 to an impedance detection module 324 that generates a displacement output to the plant 330.

In this example, the impedance detection module 324 operates based on:

$${F}_{a} = {M}_{m} ( {\ddot{X}}_{d} - \ddot{X} ) + {D}_{m} ( {\dot{X}}_{d} - \dot{X} ) + {K}_{m} ( {X}_{d} - X )$$

Where Fₐ is the pinch force and Mₘ, Dₘ and Kₘ are gain parameters.

The impedance detection module 324 utilizes a mass-spring-damper model and appropriate gain parameters to ensure soft contact between the moveable device and the obstruction without measuring force feedback Fₑ. In situations where no obstruction is detected, the pinch force (Fₐ) will be zero and the desired displacement (X_{d}) will equal the actual displacement (X). In situations where an obstruction is detected, then Fₐ≠0, and the actual displacement X does not track the desired displacement X_{d} (or X_{d}≠X).

Impedance control provides soft contact by targeting low contact forces (Fₐ) using appropriate impedance gain parameters. In some examples, the parameter Mₘ is set higher than the parameters Dₘ and Kₘ. Higher mass/inertia will reduce acceleration, velocity, and position. In some examples, the parameter Kₘ is set lower to provide less counteracting of Fₐ.

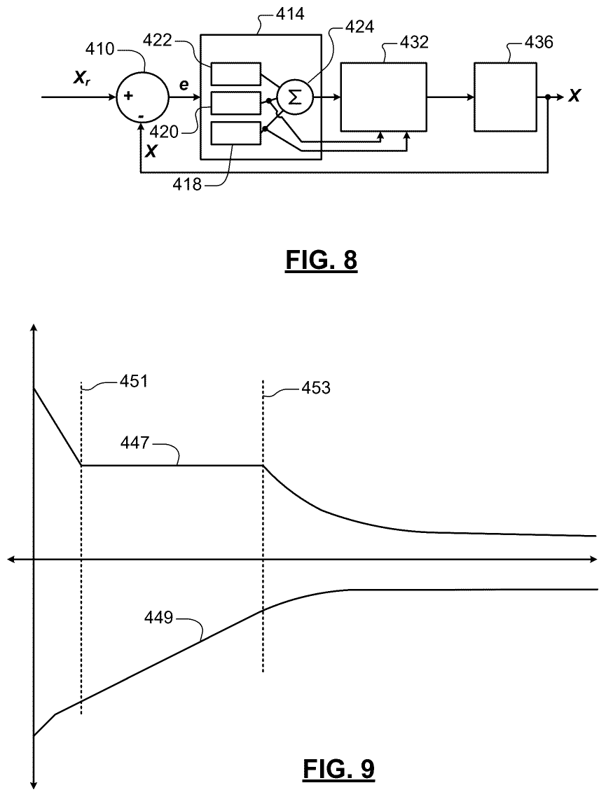

Referring now to FIGS. 8 to 10, another example of a control system for with pinch control is shown. In FIG. 8, a non-inventing input of a summer 410 receives a reference displacement Xᵣ and an inverting input of the summer 410 receives an actual displacement X and generates an error e. The error e is input to a PID module 414 that includes a proportional module 418 that generates a proportional term, an integral module 420 that generates an integral term, and a derivative module 422 that generates a derivative term based on the error. The PID module 414 includes a summer 424 that generates a sum by summing the proportional term, the integral term, and the derivative term.

An impedance controller 432 receives the sum, the proportional term, and the integral term. In FIG. 9, the impedance controller 432 monitors the proportional term (at 447) and the integral term (at 449) to detect an increase in the integral term without an increase in the proportional term which occurs between dotted lines 451 and 453. When the impedance controller 432 detects the pinch force due to an obstruction, the impedance controller 432 takes appropriate remedial action at 474.

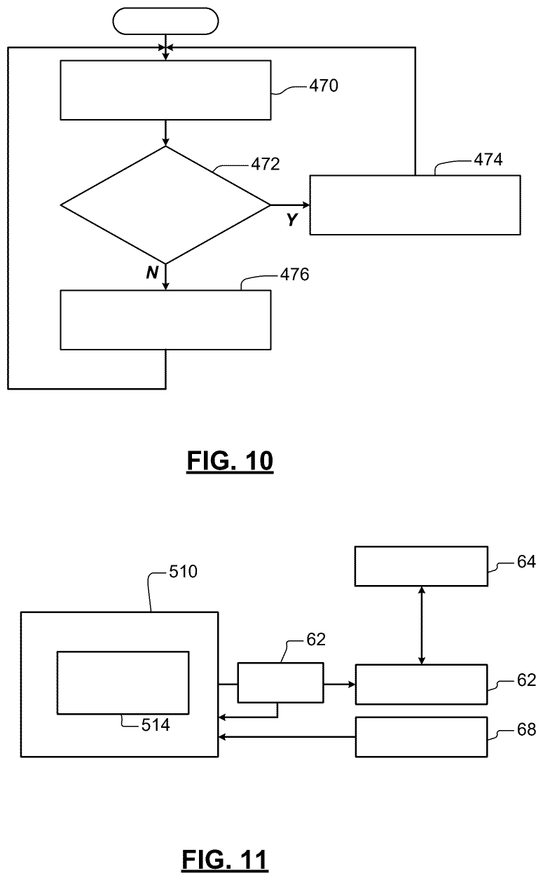

In FIG. 10, the impedance controller 432 receives the sum, the proportional term, and the integral term at 470. At 472, the impedance controller 432 determines whether there is an increase in the integral term without an increase in the proportional term. If 472 is true, the method continues at 474 and detects the pinch event and takes remedial action such as reversing the motor or other actions described herein. If 472 is false, the motor is controlled using the sum from the PID module.

Referring now to FIG. 11, a controller 510 includes a gradient current-based impedance detection module 514 configured to detect an impedance based on current gradient of current supplied to the motor 62. The gradient current-based impedance detection module 514 monitors a current supplied to the motor 62 and generates a current gradient based on the supplied current. The gradient current-based impedance detection module 514 compares the current gradient to a predetermined current gradient threshold and selectively adjusts operation based thereon. In some examples, the current gradient exceeds the predetermined current gradient threshold when the obstruction is detected. In some examples, the gradient current-based impedance detection module 514 is used along with a PID control module as shown above. The PID control module controls the motor when the obstruction is not detected.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A control system for a moveable device of a vehicle, comprising:
a position sensor configured to measure an actual displacement of the moveable device;
a force transducer configured to measure a force applied by a motor to adjust a position of the moveable device;
an impedance detection module configured to generate a reference displacement in response to a desired displacement and the force;
a summer configured to generate an error in response to the reference displacement and the actual displacement; and
a control module configured to output a revised desired displacement to control the motor in response to the error.

2. The control system of claim 1, wherein the moveable device includes an electronic active aerodynamic (EAA) system.

3. The control system of claim 2, wherein the moveable device includes an adjustable shutter.

4. The control system of claim 2, wherein the moveable device includes an adjustable spoiler.

5. The control system of claim 1, wherein the impedance detection module selectively determines the reference displacement in response to a relationship:
$${X}_{r} = \frac{{F}_{e} - {M}_{r} ( {\ddot{X}}_{r} - {\ddot{X}}_{d} ) - {D}_{r} ( {\dot{X}}_{r} - {\dot{X}}_{d} )}{{K}_{r}} + {X}_{d}$$
where Mᵣ, Dᵣ, and Kᵣ are constant gain parameters that define soft contact, Xᵣ is the reference displacement, X_{d} is the desired displacement, \ddot{X}ᵣ is a reference acceleration, \ddot{X}_{d} is a desired acceleration, \dot{X}ᵣ is a reference velocity, and \dot{X}_{d} is a desired velocity.

6. The control system of claim 5, wherein at least one of:
the impedance detection module sets the desired displacement equal to the reference displacement at vehicle speeds greater than a predetermined vehicle speed; and
the impedance detection module sets the desired displacement equal to the reference displacement when the moveable device is moved in a first direction and based on the relationship when the moveable device is moved in a second direction opposite to the first direction.

7. The control system of claim 5, wherein:
when the impedance detection module detects an obstruction, the impedance detection module is configured to take remedial action including at least one of stopping forward motion, reversing for a predetermined period, reversing by a predetermined distance, or pausing for a predetermined period;
after the remedial action, the impedance detection module is configured to re-attempt forward motion; and
if the obstruction is detected by the impedance detection module after re-attempting forward motion, the impedance detection module is configured to reverse to a starting position.

8. A control system for a moveable device of a vehicle, comprising:
a position sensor configured to measure an actual displacement of the moveable device;
a summer configured to generate an error in response to a desired displacement and the actual displacement;
a control module configured to generate a displacement output in response to the error;
a force transducer configured to measure a force applied by a motor to adjust a position of the moveable device; and
an impedance detection module configured to sense an obstruction based on the force and to generate a revised reference displacement to control a motor moving the moveable device in response to the displacement output and the force.

9. The control system of claim 8, wherein the moveable device includes an electronic active aerodynamic (EAA) system.

10. The control system of claim 9, wherein the moveable device includes an adjustable shutter.

11. The control system of claim 9, wherein the moveable device includes an adjustable spoiler.

12. The control system of claim 10, wherein at least one of:
the impedance detection module sets the desired displacement based on the displacement output at vehicle speeds greater than a predetermined vehicle speed; and
the impedance detection module sets the desired displacement based on the displacement output when the moveable device is moved in a first direction and based on the force and the displacement output when the moveable device is moved in a second direction opposite to the first direction.

13. The control system of claim 6, wherein:
when the impedance detection module detects an obstruction, the impedance detection module is configured to take remedial action including at least one of stopping forward motion, reversing for a predetermined period, reversing by a predetermined distance, or pausing for a predetermined period;
after the remedial action, the impedance detection module is configured to re-attempt forward motion; and
if the obstruction is detected by the impedance detection module after re-attempting forward motion, the impedance detection module is configured to reverse to a starting position.

14. A control system for controlling a position of a moveable device of a vehicle, comprising:
a position sensor configured to measure an actual displacement of the moveable device;
a summer configured to generate an error in response to a desired displacement and the actual displacement; and
an impedance detection module configured to:
receive the desired displacement and the actual displacement;
estimate a pinch force in response to a sum of products of a position difference and a first gain, a velocity difference and a second gain, and an acceleration difference and a third gain; and
generate an output displacement for a motor moving the moveable device based on the error when the pinch force is zero and take remedial action when the pinch force is not zero.

15. The control system of claim 14, wherein the moveable device includes an electronic active aerodynamic (EAA) system.

16. The control system of claim 14, wherein the moveable device includes an adjustable shutter.

17. The control system of claim 14, wherein the moveable device includes an adjustable spoiler.

18. The control system of claim 14, wherein at least one of:
the impedance detection module sets the output displacement based on the error at vehicle speeds greater than a predetermined vehicle speed; and
the impedance detection module sets the output displacement based on the error when the moveable device is moved in a first direction; and
the impedance detection module sets the output displacement based on the error and the pinch force when the moveable device is moved in a second direction opposite to the first direction.

19. The control system of claim 14, wherein:
when the impedance detection module detects an obstruction based on the pinch force, the impedance detection module is configured to take remedial action including at least one of stopping forward motion, reversing for a predetermined period, reversing by a predetermined distance, or pausing for a predetermined period; and
after the remedial action, the impedance detection module is configured to re-attempt forward motion.

20. The control system of claim 19, wherein if the obstruction is detected by the impedance detection module after the remedial action, the impedance detection module is configured to reverse to a starting position.
